(19) United States
(12) Patent Application Publication
(10) Pub. No.: US 2009/0115847 A1
(43) Pub. Date: May 7, 2009

(54) ELECTRONIC AUTOMOBILE PROXIMITY VIEWER

(76) Inventor: Leroy E. Anderson, Boise, ID (US)

Correspondence Address: DYKAS, SHAVER & NIPPER, LLP, P.O. BOX 877, BOISE, ID, 83701-0877, US

(21) Appl. No.: 12/267,382

(22) Filed: Nov. 7, 2008

Related U.S. Application Data
(60) Provisional application No. 60/986,148, filed on Nov. 7, 2007.

(51) Int. Cl. H04N 7/18

(52) U.S. Cl. 348/148; 348/E07.085

(57) ABSTRACT

An electronic automobile proximity viewer for with a viewscreen mounted on a dashboard of an automobile, and one or more digital camera units mounted at peripheral locations of an automobile. From the view screen the use can select which image from which camera unit to view, and can direct the selected camera unit to zoom in on an object near the automobile, including zooming in to regions of the selected image which are not in the center of the image.

### CROSS-REFERENCE TO RELATED APPLICATIONS

This application claims the priority date of the provisional application entitled PEEPHOLE VIEWER filed by Leroy E. Anderson on Nov. 7, 2007 with application Ser. No. 60/986,148.

### FIELD OF THE INVENTION

The invention generally relates to an apparatus for viewing items near a vehicle, and more particularly to a digital device for viewing and zooming in on an object in the proximity of an automobile.

### BACKGROUND OF THE INVENTION

There is a need for an electronic proximity viewer for automobiles so that the driver can view what objects that are near the automobile. Some prior art devices exist to assist in backing, for instance. None of these are known to have zoom capabilities, and the zoom capability that is available in digital viewers such as camera screens is a straight out zoom. That means that when the zoom is activated, the center of the screen is magnified, so any objects not in the center of the screen become not visible in the zoomed image. What is needed is a zoom feature for use in an automobile viewer which has the capability to zoom to an off center location, to better view objects near the automobile.

### SUMMARY OF THE INVENTION

The invention is an electronic proximity viewer for automobiles which includes a digital camera lens, a digital viewing screen, a zoom feature, and a zoom activation button. The digital camera lens is configured for mounting into a position adjacent to a region to be viewed, such as the rear of a vehicle, the rear corners of the vehicle, the front of the vehicle, or the from corners of the vehicle, with the region to be viewed located at some distance remote from the user of the electronic proximity viewer for automobiles. The digital viewing screen is configured for mounting at some distance from the digital camera lens, such as on the dashboard of the vehicle, and is electrically connected to the digital camera lens either by wireless or by wired configuration. The digital viewing screen is positioned in a convenient position for the user of the electronic proximity viewer for automobiles to view an image on the digital viewing screen, with that position typically being the vehicle dashboard. The viewing screen can also be mounted in the visor of the automobile, in the center console, or in the ceiling panel of the automobile.

The electronic proximity viewer for automobiles includes a zoom feature that selects a region in the displayed image for magnification, with that region may be a region other than the center of the image. The typical zoom lens zooms towards the center of the image and makes the center of an image larger. The zoom feature of this device can zoom to a region that is not the center of the picture, and that, in one version, can be selectable by the user. For instance, the viewer may be configured to zoom to the lower center of the image. This kind of a zoom would be useful if the electronic proximity viewer for automobiles is positioned at the rear of an automobile, and the digital camera lens was directed in the general direction of behind the automobile. Zooming to the center bottom of the image would allow the user to get a better view of the trailer hitch and the connection of the trailer hitch to a towed vehicle, for instance.

A zoom activation button is included that can take a number of different forms which will be discussed below. An image which is viewed in the digital viewing screen is magnified when the zoom activation button is activated and the image is magnified to show greater detail in that part of the image which is selected.

A preferred version of the device may be configured specifically to zoom in on the lower center, or other zones of the displayed image. The zoom feature can be based on optics in the digital camera lens and also can be based on software enhancement of the image by digital manipulation. The zoom feature can also be specifically configured to zoom in on the lower right region of the image, or the lower left region of the image. The device can also be configured with the capacity to zoom in on more than one region of the image, with the selection of the zone or region for zooming in being left to the user's control. In such a case, a zone selection button would be provided, which would allow the region of the image selected for magnification to be identified by the user. The zone selection button can be in the form of a touch screen button, such as allowing the user to merely touch the lower center, lower right, lower left, upper center, upper right, upper left at his discretion, or a representation of those zones, with the resulting magnification of that zone of the image. The zone selection button can also take the form of a button which is activated repeatedly, and the selection area cycled through the different options of regions for magnification until the user selects which view he would like to have magnified.

The electronic proximity viewer for automobiles can also have a magnification button, with which the user selects from a number of different levels of magnification. The electronic proximity viewer for automobiles can also have a brightness button to allow the user to adjust the brightness of the image to a preferred level of brightness.

One version of the electronic proximity viewer for automobiles is a version in which the digital camera lens is positioned at the rear of an automobile, such as adjacent to the license plate. The digital viewing screen would be placed in or around the dash board of the automobile. This version of the device could be fitted to any automobile as an after market installation, or could be built into the automobile in the manufacturing process. When placed adjacent to the license plate, in the rear center of the automobile, the zoom function would be particularly useful to magnify an image of objects directly behind the vehicle. Another version of the invention would have digital camera units in one or more corner of the automobile, such as adjacent to brake and turn signal lights, for viewing objects close to any of the four corners of the automobile.

An object detection system could be added so an alarm will be sounded when an object is detected within a specified distance or distances. This will then alert the driver and he can check the monitor to see what it is. He can check the area he wishes to see and have it magnified for better view. For night or better vision, LED lights can be added and directed to various areas that you want lit up to appear on your monitor.

Another version of the electronic proximity viewer for automobiles includes a night light camera, which is a camera that is adjusted to provide visibility in low light situations.

The electronic proximity viewer for automobiles of the invention can be configured to operate with battery power or ac power, with rechargeable batteries, 12 Volt DC, run off a car cigarette lighter or any combination of those electrical sources.

Features of Automotive Backup Viewer:
A. Camera with remote, regular screen, monitor with button for desired viewing area and button for desired magnification.
B. Multiple cameras with button for which cameras desired to view.
C. Cameras with touch screen with buttons for areas of magnification.
D. Multiple cameras with touch screen with buttons for which area to view and magnification desired.
E. An object detection system added to any of the above so a sound alarm will be given when an object is within a specified distance or distances.

Any of the above my have button for variable brightness.

An L.E.D. light or lights may be added to be aimed at area wished to be lighted and controlled by area to be viewed, lights aimed at various areas.

Any of the above programs may be used with a night or low light camera and with or without L.E.D. light or lights.

The device also includes a digital viewing screen unit with a view screen for mounting inside the vehicle. The digital viewing screen unit is operationally connected to a digital camera lens unit for convenient viewing of objects near the automobile. The operational connection may be by conventional wires or it may be by a wireless connection using any number of wireless formats.

### BRIEF DESCRIPTION OF THE DRAWINGS

FIG. 1 is a view of the electronic automobile proximity viewer of the invention without the automobile.

FIG. 2 is a side view showing the digital camera lens unit viewing an object near the rear of the automobile.

FIG. 3 is a top view of multiple digital camera lens units on an automobile.

FIG. 4 is a front view of the digital viewing screen unit mounted on a dash board.

### DESCRIPTION OF THE PREFERRED EMBODIMENTS

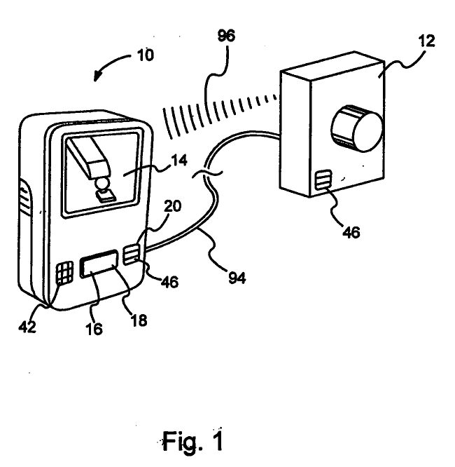

The electronic automobile proximity viewer of the invention is shown in FIGS. 1 through 4. FIG. 1 shows a digital camera lens 12 and a digital viewing screen 14. The digital view screen 14 includes a zoom point selector pad 42 by which the user specifies which portion of the screen to zoom in on. It also includes an off center zoom feature 16 and an off center zoom feature activation button. After selecting the portion of the view screen to zoom in on using the zoom point selection pad 42, pressing the off center activation button 18 causes the image to zoom in on the selected portion of the image. The device shown in FIG. 1 includes a speaker/microphone 46 in both the digital viewing screen unit and the digital camera lens unit 14 and 12.

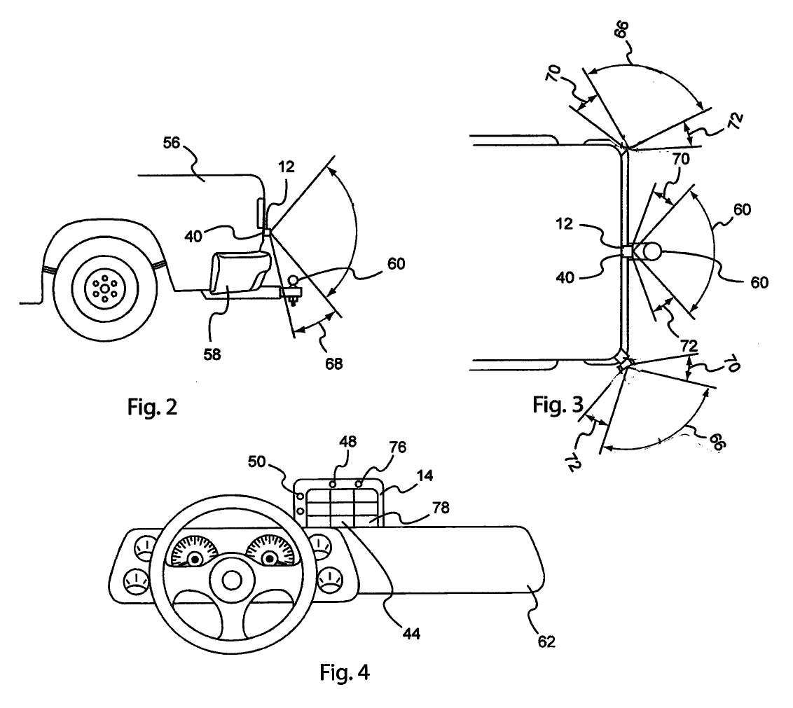

FIG. 2 is a side view of the rear of an automobile showing the field of view of the digital viewer. The digital camera lens unit 12 is positioned near the bumper 58 of the vehicle and includes a light source 40 for illuminating objects near the automobile in low light situations. The default range of the camera is shown in the angle designated 66. This particular range of camera would be useful to identify the position of a car behind that of the user, for purposes of backing up. As the user's automobile backs up, the relative position of the adjacent automobile can be tracked. The driver of the vehicle could utilize the off center zoom feature to change the angle of the camera toward a downward viewing angle which is shown as 68. Using this viewing angle the bumper of the adjacent auto can be monitored.

FIG. 3 shows the digital camera lens unit 12 with a light source 40 mounted adjacent to a digital camera lens unit 74. The default range of the camera is shown as 66, with a range 70 showing what a camera would see if it zoomed to the left, and a range 72 showing what a camera would see if it zoomed to the right. Also shown are camera lens units 74 mounted on the sides of the automobile, adjacent to or incorporated in the brake and turn signal light assemblies of the automobile, with these camera lens unit positions utilized with the system in order to allow views to the side of the automobile. The electronic proximity viewer for automobiles 10 of the invention can further include a speaker/microphone 46 which is shown in FIG. 2.

The electronic proximity viewer for automobiles 10 of the invention also has the capability of zooming in on an object with a zoom feature which is capable of zooming to an off-center region of the screen as well as to the center of the image. It is common in the prior art for an electronic viewing device to zoom straight forward and to magnify the portion of the screen which is in the center of the screen. This is generally a workable practice in Items such as cameras. However, in a viewer which is utilized in a vehicle proximity viewer situation, it is more advantageous to also be able to zoom to an area that is not in the center of the view screen. This requires the use of a zoom point selection pad which can be in the form of a pad of buttons shown in FIG. 4, or can be in the form of a touch screen zoom selection such as shown in FIG. 4. By choosing the zone to zoom towards, the view screen zooms, for instance, to the lower bottom of the screen, the lower left or right, the right side of the screen, the left side of the screen, or the center left or right upper part of the screen.

FIG. 4 also shows a magnification button 50, and a brightness button 48. The brightness button 48 can be tapped to increase the brightness of the image. FIG. 4 also shows an alarm for proximity of objects to the automobile, and a selector for auxiliary cameras. The zone selection can be by touching the grid shown in FIG. 4, with nine sectors representing zones that can be magnified at the selection of the user.

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An electronic proximity viewer for automobiles for automobiles, comprising:
at least one digital camera lens units for mounting on an automobile in a position for viewing one or more regions near said automobile for viewing objects near said automobile, with said region to be viewed remote from a user of said electronic proximity viewer for automobiles;
a digital viewing screen unit for mounting inside said automobile in a position at a convenient to the user and distant from said digital camera lens, for convenient viewing of said region near said automobile, said digital viewing screen unit having a view screen;
a off center zoom feature in said viewing screen unit in which a selected region is magnified, in which the region magnified includes regions other than the center of the image of said region to be viewed;
a zoom activation button; and
a zone selection button; wherein
an image viewed in the digital viewing screen is magnified when said zoom activation button, and said image is magnified to show greater detail of a part of the image including regions of the image other than the center of the image.

2. The electronic proximity viewer for automobiles of claim 1 in which said zoom feature is configured to magnify a region of said image located in the lower center of said image.

3. The electronic proximity viewer for automobiles of claim 1 in which said zoom feature is based on software magnification of said image.

4. The electronic proximity viewer for automobiles of claim 1 in which said zoom feature is configured to magnify a region of said image located in the lower right of said image.

5. The electronic proximity viewer for automobiles of claim 1 in which said zoom feature is configured to magnify a region of said image located in the lower left of said image.

6. The electronic proximity viewer for automobiles of claim 1 in which said zoom feature is configured to magnify one of a plurality of regions of said image, in which the region to be magnified is not the center of the image.

7. The electronic proximity viewer for automobiles of claim 1 in which said electronic proximity viewer for automobiles further comprises a zone selection button in the form of a touch screen, for selecting a region of said image to magnify.

8. The electronic proximity viewer for automobiles of claim 1 in which digital camera lens' said zoom feature is configured to magnify one of a plurality of regions of said image, in which the region to be magnified is not the center of the image.

9. The electronic proximity viewer for automobiles of claim 1 which further comprises a magnification button to change magnification to different levels of magnification.

10. The electronic proximity viewer for automobiles of claim 1 which further comprises a brightness button to change brightness of said image to different levels of brightness.

11. The electronic proximity viewer for automobiles of claim 1 in which said digital camera lens is configured for mounting on the rear of an automobile, for viewing a region behind said automobile.

12. The electronic proximity viewer for automobiles of claim 1 in which said digital camera lens is configured for mounting on the left and right rear corners of an automobile, for viewing a region adjacent to the left and right rear corners of said automobile.

13. The electronic proximity viewer for automobiles of claim 1 which further comprises a light source which may be activated to illuminate a region adjacent the automobile.

14. The electronic proximity viewer for automobiles of claim 1 which further includes a plurality of digital camera lens units placed at selected locations around a vehicle, with said viewing screen having a camera selection button to select one of said digital camera lenses from which to display an image on said monitor.

15. The electronic proximity viewer for automobiles of claim 14 which further comprises a zone selection means to select a region on each image of each camera for viewing, and a magnification means for magnification of the selected region of the selected image.

16. The electronic proximity viewer for automobiles of claim 14 which further comprises a magnification selection means for selecting different levels of magnification for the image selected from the various cameras.

17. The electronic proximity viewer for automobiles of claim 14, which further includes an alarm configured to sound when an object is within a specified distance of the viewer.
